(19) United States
(12) Patent Application Publication
(10) Pub. No.: US 2010/0146002 A1
(43) Pub. Date: Jun. 10, 2010

(54) CAPTURING ENTERPRISE ARCHITECTURES

(75) Inventors: Wolfgang Mayle, Crailsheim (DE); Sebastian Rothbucher, Frankfurt (DE)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/329,873

(22) Filed: Dec. 8, 2008

(51) Int. Cl. G06F 17/30; G06F 7/00

(52) U.S. Cl. 707/792; 707/E17.044

(57) ABSTRACT

A computer based system for capturing and storing enterprise architecture information includes a database for storing artifacts, each artifact representing a portion of the enterprise architecture. The system includes a user interaction module coupled to the database and a connection support document and artifact viewer coupled to the structured artifact listing, the connection support document viewer configured to display connection support documents, each connection support document pointing to two connected artifacts and containing additional information about a relationship between the two linked artifacts.

### BACKGROUND

The present invention relates to enterprise architectures, and more specifically, to electronically capturing enterprise architectures utilizing interconnected enterprise artifacts.

Enterprise architecture (EA) is a term used to describe the practice of documenting the elements of business strategy, business case, business model, supporting technologies, policies and infrastructures that make up an enterprise. There are multiple architecture frameworks that describe EA. For instance, EA can be described as documentation describing the structure and behavior of an enterprise and its information systems, usually in a number of architecture domains. EA may, alternatively, be described as a process for describing an enterprise and its information systems and planning changes to improve the integrity and flexibility of the enterprise. Regardless of the description, EA is proving to be a valuable tool for enterprises of all sizes and aids in the assessment and planning required for successful enterprises.

Describing complex systems such as an enterprise is, however, difficult if a structured approach is not taken. An enterprise, as the term is used herein, shall refer to any company, partnership, or the like having multiple policies.

Many so-called “metamodels” for describing aspects of a particular enterprise have been created in the past. These metamodels, however, are mostly on the conceptual level and insufficiently supported automated tools. The result is a description of a complex system that is handled by utilizing static documents created in Word or PowerPoint or the like. Models created this way are hard to maintain, hard to manage over time, hard to elaborate, hard to understand and hard to analyze. For example, PowerPoint documents are static documents that produce “snapshots,” have one fact on several places, and are purely linear. These linear linkages makes the snapshots hard to change and, thus, are likely to become shelfware. Furthermore, existing systems to capture enterprise architecture information rely mostly on measurement administration and calculation or are very closed and not capable of handling different metamodels or extending them.

### SUMMARY

According to one embodiment of the present invention a computer based system for capturing and storing enterprise architecture information is provided. The system of this embodiment includes a database for storing artifacts, each artifact representing a portion of the enterprise architecture and a user interaction module coupled to the database. The user interaction module includes a structured artifact listing containing a listing of each artifact, the artifact listing including a representation of each bidirectional connection between each artifact; a selection module for selecting one or more of the artifacts, wherein selection of an artifact causes the selected artifact and all artifacts connected to the selected artifact to be displayed; and a connection support document viewer coupled to the structured artifact listing, the connection support document viewer configured to display connection support documents, each connection support document pointing to two connected artifacts and containing additional information about a relationship between the two linked artifacts.

Another embodiment of the present invention is directed to a method of storing enterprise architecture in a computer database. The method of this embodiment includes creating a plurality of artifacts including a first artifact, a second artifact and a third artifact, each artifact having a type and an identifier; creating a connection between the first artifact and the second artifact, the connection including a forward link stored in the first artifact pointing from the first artifact to the second artifact and a reverse link stored in the second artifact pointing from the second artifact to the first artifact; and creating a connection support document, the connection support document including a pointer to the first artifact and a pointer to the second artifact, the connection support document further including information related to the connection between the first artifact and the second artifact.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 shows an example of a computing system on which embodiments of the present invention may be implemented;

FIG. 2 shows a block diagram representation of a hierarchical structure of an EA capturing system according to an embodiment of the present invention;

FIG. 3 shows an example of a metamodel for interconnected artifacts according to one embodiment of the present invention;

FIG. 4 shows an example of two interconnected artifacts that also include a connection support document further describing the connections between the two artifacts;

FIG. 5 shows a method according to an embodiment of the present invention by which one artifact may be linked to another artifact;

FIG. 6 shows a method according to an embodiment of the present invention by which connections between artifacts may be altered; and

FIG. 7 shows another example of interconnected artifacts according to one embodiment of the present invention.

### DETAILED DESCRIPTION

It has been noted that enterprise architecture (EA) information is rather coarse-grained, very interconnected, highly structured and may be ideal for different views or even reports. In addition, EA information evolves over time and, thus, needs lifecycle management. The prior methods of generating static documents describing EA do not allow for automatic the generation of reports, are not easily alterable and lifecycle management is a de facto manual task because the static documents are not linked in an organized manner allowing for changes in one document to be propagated through other documents in the enterprise architecture.

Embodiments of the present invention may overcome some or all of these drawbacks, and others, by providing a framework for storing structured and interconnected data. Aspects of the present invention provide for interconnected artifacts generated by manual analysis which describe portions of the enterprise. Enterprises can for instance be further described in terms of components (one type of artifact) with additional information such as strategies and principles. These components and other artifacts can be stored in a database system. Indeed, embodiments of the present invention may store and manage over time any type of interconnected EA artifact, thus providing a living asset to develop an enterprise's business and IT capabilities.

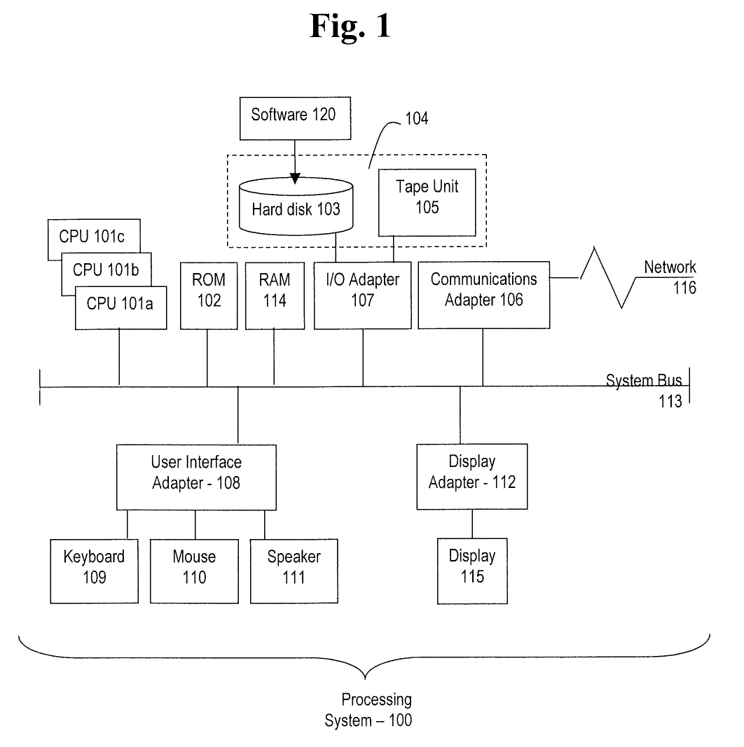

FIG. 1 shows an embodiment of a computing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

The system may also include an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. In one embodiment, the mass storage may include or be implemented as a database for storing enterprise architecture information. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 1, the system 100 includes processing means in the form of processors 101, storage means including system memory 114 and mass storage 104, input means such as keyboard 109 and mouse 110, and output means including speaker 111 and display 115. In one embodiment, a portion of system memory 114 and mass storage 104 collectively store an operating system such as the AIX® operating system from IBM Corporation to coordinate the functions of the various components shown in FIG. 1.

It will be appreciated that the system 100 can be any suitable computer or computing platform, and may include a terminal, wireless device, information appliance, device, workstation, mini-computer, mainframe computer, personal digital assistant (PDA) or other computing device.

Examples of operating systems that may be supported by the system 100 include Windows 95, Windows 98, Windows NT 4.0, Windows XP, Windows 2000, Windows CE, Windows Vista, Macintosh, Java, LINUX, and UNIX, or any other suitable operating system. The system 100 also includes a network interface 116 for communicating over a network. The network can be a local-area network (LAN), a metro-area network (MAN), or wide-area network (WAN), such as the Internet.

Users of the system 100 can connect to the network 116 through any suitable network adapter 106, such as standard telephone lines, digital subscriber line, LAN or WAN links (e.g., T1, T3), broadband connections (Frame Relay, ATM), and wireless connections (e.g., 802.11(a), 802.11(b), 802.11(g)).

As disclosed herein, the system 100 includes machine readable instructions stored on machine readable media (for example, the hard disk 104) for capture and interactive display of information shown on the screen 115 of a user. As discussed herein, the instructions are referred to as “software” 120. The software 120 may be produced using software development tools as are known in the art. The software 120 may include various tools and features for providing user interaction capabilities as are known in the art.

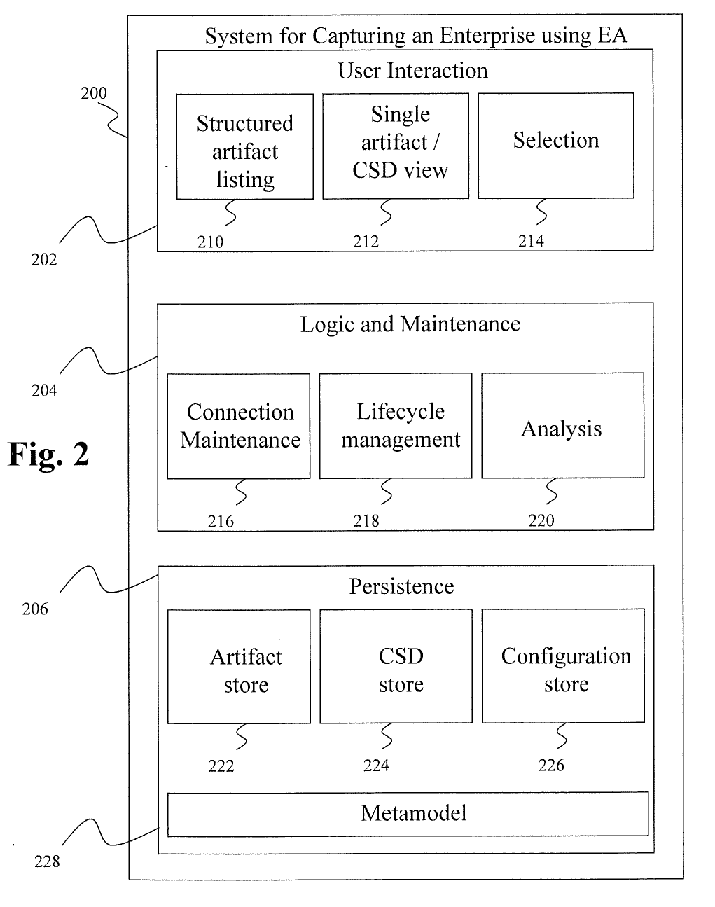

FIG. 2 shows a hierarchical system 200 according to one embodiment of the present invention. The hierarchical system 200 may be stored in any type computer memory, executed in any implementation of system 100 (FIG. 1) and may be stored on one or amongst many interconnected computers.

It should be understood, and is described in greater detail below, that certain building blocks are utilized in the present invention. The most basic building block is referred to herein as an artifact. An artifact may be any type of document or entity that is stored in the EA system. Each artifact may have specific attributes. In one embodiment, the attributes are semantic attributes such that the EA may be implemented as a semantic network. A semantic network is often used as a form of knowledge representation. It is a directed or undirected graph consisting of vertices, which represent concepts, and edges, which represent semantic relations between the concepts.

Each artifact is stored and, where applicable, linked to other artifacts. The interconnections between artifacts are also stored, as well as lifecycle information related to the artifact. The interconnections may be referred to herein as a connection, link, or reference. In one embodiment, a connection between two artifacts is always a bi-directional connection. That is, for example, the connection between artifacts A and B is actually two connections, a connection from A to B and a connection from B to A. The link from artifact A to artifact B may be referred to herein as a forward link and the link from artifact B to artifact A may be referred to as a reverse or backward link. Links may be stored within the artifacts.

Additional information about each link may be stored in a connection support document (CSD) that provides information about a particular connection between two artifacts. The CSD points to both artifacts (i.e. has a pointer to artifact A and artifact B) and may also include additional arbitrary name-value-pairs. For example, in the context of a supply stream modeled as an EA, the CSD may contain an indication how many parts represented by artifact A may be needed to produce a product represented by artifact B.

The hierarchical system 200 may include several different modules. For example, the hierarchical system 200 may include a user interaction module 202, a logic and maintenance module 204, and persistence module 206.

In one embodiment, the user interaction module 202 includes some or all of the components that allow a user to create, read, update, delete and list the database contents. That is, the user interaction module 202 may allow for artifacts to be created and linked to one another. As in all EA applications, such abilities are vital for effective EA usage because EA information, at the artifact level is manually maintained. The interaction module 202 may include, a structured artifact listing 210, a single artifact/csd (connection support document) view 212 and a selection component 214.

The structured artifact listing 210 may allow for listing a set of artifacts (that is a subset or equal to the set of all artifacts in the database). The artifacts satisfy certain conditions (such as being of a certain type and/or having a certain lifecycle status). The listing can be grouped by any property of an artifact, e.g. artifact type, category or lifecycle status.

The single artifact/CSD view 212 may show one artifact or connection support document (connection support documents can be reached by the user via linking in the single artifact view). This module may be called whenever an artifact is opened from the structured artifact listing 210. It may allow for viewing and editing all properties of the artifact (except its type). It also allows the creating of links to other artifacts. Connection support documents may also be presented to the user as such links. After editing, saving of documents is possible that ensures that logic (in the logic and maintenance module 204) is called as, appropriate, to ensure consistency and accuracy of data.

The selection component 214 may be used in single artifact views when editing an artifact. The selection component 214 may also allow for choosing other artifacts the particular artifact is to be linked to.

The system 200 may also include a logic and maintenance module 204. The logic and maintenance module may be called whenever artifacts or CSDs are edited and saved or based on explicit user invocation. It ensures both data correctness and accuracy and handles lifecycle and other analytical functions. The logic and maintenance module 204 may include a connection maintenance module 216, a lifecycle management module 218 and an optional analysis module 220.

The connection maintenance module 216 may be configured to ensure that connections are always bidirectional and consistent. When a connection is specified (by configuration) as one that has no CSD attached with it, both linked artifacts are updated so that both references and data presented to the user are always consistent. That is, whenever a “forward” link is made from artifact A to artifact B that link is stored as a part of artifact A. In addition, a reverse link, from artifact B to artifact A, is stored in as part of artifact B. When a connection is specified (by configuration) as one that has a CSD attached with it, all of the before applies as well plus the CSD is created if it has not already been created. Furthermore, both linked artifacts and CSD's are updated so that both references and data presented to the user are always consistent. That is, whenever a “forward” link is made from artifact A to artifact B that link is stored as a part of artifact A. In addition, a reverse link, from artifact B to artifact A, is stored in as part of artifact B. Further, in the event that a CSD is created, the CSD is configured to point to both artifact A and artifact B. Likewise, when a “forward” link from A to B is modified (i.e. altered, added, or deleted), the “reverse” link from B to A is also modified (i.e. altered, added or deleted). In the event that a CSD is specified that points to A and B, this CSD is also deleted when the links are deleted.

The lifecycle management module 218 may be configured to handle management of lifecycle aspects of the present invention. For example, a particular artifact may be related to a software application that has a license term or expected lifecycle. In one embodiment, the user may not be to view or edit this lifecycle information based on particular settings. The lifecycle management module 218 may also be configured to handle notifications, possibly via e-mail or similar mechanisms outside the system when documents are due for updates and determines who is responsible for implementing or reviewing a particular update.

The optional analysis module 220 may be configured to analyze connections based on user-desired criteria. In addition, the analysis module 220 may allow for the generation of reports showing information from the database. For example, the analysis module 220 may be utilized to examine whether particular business practices are following defined patterns or protocols.

The persistence module 206 may be configured to summarize all functions to store the information in a way that is persistent (i.e. database functionality). In one embodiment, four pieces of information need to be stored and retrieved based on properties or links. These pieces of information include the artifacts themselves along with all properties, which are both stored in artifact store 222, the CSDs stored in the CSD store 224, and the configuration settings stored in configuration store 226. The configuration store 226 may store, for example, when a CSD is to be created, which categories exist, whom to send notifications, and choices in picklists. The information may also include the metamodel stored in the metamodel store 228. This information defines the structure of the artifacts that can be used. These structures are referred to as metamodels.

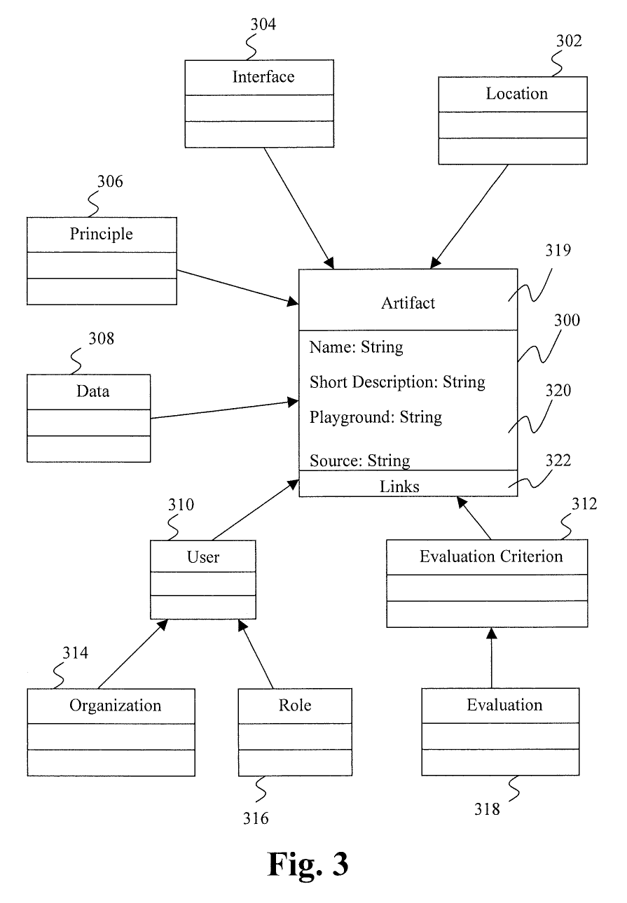

FIG. 3 is an example for a metamodel as it can be stored in the metamodel store 228 (FIG. 2). In FIG. 3 several examples for artifacts are shown. In one embodiment, Principles, Interfaces, Locations, etc. are all specific types of artifacts. Roles are specific types of users and in turn also specific types of artifacts. In addition, it should be noted for each element shown in FIG. 3, there may be several instances created to capture information about an enterprise. For instance, “Bill” and “Ted” may be two instances of a “user”. FIG. 3 is shown according to the Unified Modeling Language (UML) standard. Of course, a person of skill in the art may derive a concrete implementation from the metamodel shown in FIG. 3.

The connections according to embodiments of the present invention are implemented as bidirectional connections. According to embodiments of the present invention, artifacts may be able to refer to almost any kind of information. For non-limiting examples, artifacts could refer to locations, components, patterns, principles, standards, business components, processes, interfaces, data, users, organizations, strategy, roles, evaluations, evaluation criteria or any other type of information that may be quantified as desired by a particular enterprise.

In one embodiment, each artifact may have metadata associated with it. For example, each artifact may include a title, a type, detailed semantic information, a linking collection that may includes a separate section for each type of different link, a map from an artifact to a particular link type, and a link to a graphical representation for the particular artifact.

By keeping a listing of links, a particular artifact 300 may serve as the basis for generating the graphical representation of connected artifacts. For example, examination of all links of the artifact 300 may reveal 0 to n instances of each of the artifacts 302, 304, 306, 308, 310, 312, 314, 316 and 318. This will depend on the configuration stored in the configuration store 226.

The artifact 300 may include an artifact type 319. The title, in some embodiments, may represent the type of artifact the artifact is as well as a caption distinct for each instance of the artifact. For example, artifact 302 is a location artifact (with instance name e.g. “Data Center”), artifact 304 is an interface artifact (with instance name e.g. “RTGS+”), artifact 306 is principle artifact (with instance name e.g. “Use of open standards”), artifact 308 is a data artifact (with instance name e.g. “Customer Information”), artifact 310 is a user artifact, artifact 312 is an evaluation criterion artifact, artifact 314 is an organization artifact 314, artifact 316 is a role artifact and artifact 318 is an evaluation artifact (with appropriate captions). These artifacts, and others, may be any type of data structure that can be stored in a computer memory, e.g. a database entity, a Lotus Notes document, an XML document, a word processing document, a spreadsheet, or any other type of description of a real world item.

The artifact 300 may also include a link store 322. The link store 322 may include, in one embodiment, all other artifacts to which the artifact 300 is connected. In one embodiment, each type of artifact has its own “type” of connection/link.

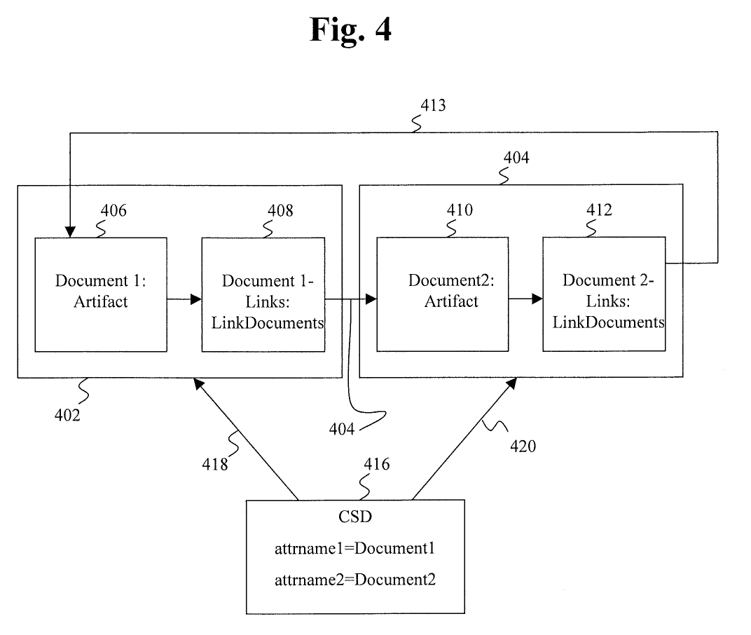

FIG. 4 shows a more detailed depiction of links/connections between a first artifact 402 and a second artifact 404. In this example, both the first artifact 402 and second artifact 404 are represented as documents. Of course, and as discussed above, the first and second artifacts 402 and 404 could be any type of artifact.

The first artifact 402 includes a document identifier 406 (Document 1) and a links portion 408. The identifier 406, in this case, indicates the artifact type, title, and other properties. The links portion 408 may, in some embodiments, contain a listing of all the links to other artifacts to which the first artifact 402 is linked. It should be noted that more than one type of link may exist. For example, a different type of link for each type of artifact may exist. For example, a special link may be declined for pattern links.

As shown, the first artifact 402 is linked to the second artifact 404 by a forward link 407. The second artifact 404 contains a document identifier 410 (Document 2) and a links portion 412. The links portion 412 of the second artifact 404 includes a reverse link 409 which points back to the first artifact 402.

In FIG. 4, the first and second artifacts 402 and 404 are also pointed to by a CSD 416 as indicated by connections 418 and 420, respectively. Some artifacts may not include a CSD. Thus, FIG. 4 is by way of example only.

According to embodiments of the present invention, each CSD connects two and only two artifacts. A CSD maybe created by user interaction when a connection between two artifacts is first made or at a later time. In some embodiments, the CSD may be automatically created for any link as it is created. In general, CSD's contain additional information about a particular link. For instance, if the supply chain of an enterprise is being documented, the CSD may include information about the number of parts produced by the organization represented by the first artifact 402 are needed by the organization represented by the second artifact 404. The information contained in a CSD is not limited in any way. In some embodiments, the information may be compliance information that define business requirements for the link. For instance, the CSD may be describing the link between two information technology (IT) components and may indicate, for example, the number of user terminals that may be connected to a single network hub. In such an instance, the first artifact 402 may indicate the number of user terminals in a particular location and the second artifact 404 is the network hub. The CSD 416 may contain information relating to the number of connections allowed. In one embodiment, comparing the numbers of user terminals connected to particular network hubs and knowing the limits may allow, for example, an IT planning process to redistribute connections to meet existing hardware or allow for forward planning of hardware procurement or redistribution.

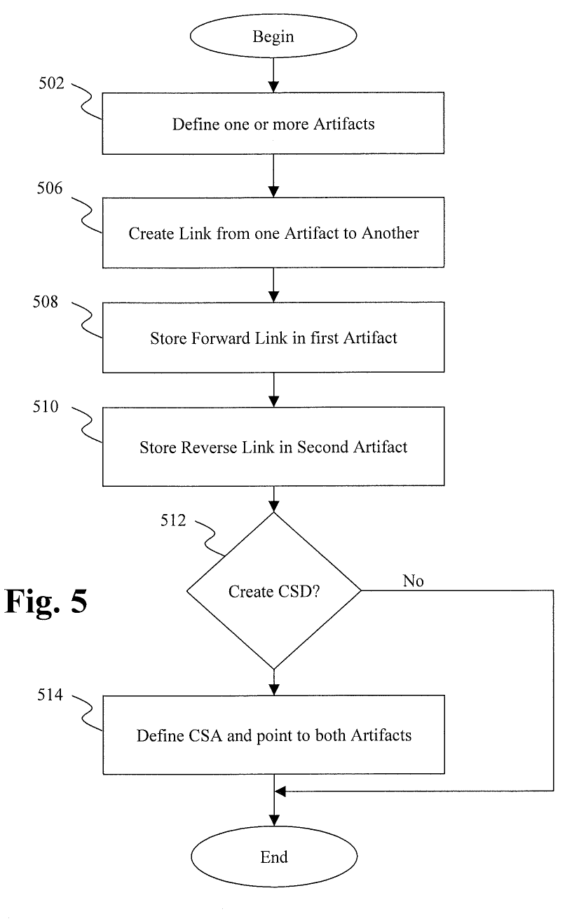

FIG. 5 shows a flow diagram of a method according to one embodiment of the present invention by which an EA architecture may be captured and stored. At a block 502 one or more artifact are defined. As discussed previously, each artifact may represent any portion of a business process or other information that may be gathered by enterprise architecture. In one embodiment a definition of an artifact includes giving it a type, a name, and other related information. As discussed previously, information for each artifact may be gleaned manually from an examination of the operations of a particular enterprise.

At a block 506, a link between one artifact and another artifact is created. The link may be created, for example, by implementing the functionality of the user interaction module 202 (FIG. 2). As discussed previously, the link may be from one type of artifact to another type of artifact. Thus, the link from the first artifact to the second artifact can be created in several different manners. For instance, each artifact could be given an icon which represents it and in an environment according to the present invention one may drag and drop links between the two. Of course other types of representation are possible and other types and means for creating the links may be within the scope of the present invention.

At a block 508, a forward link is created from the first artifact to the second artifact. This link is stored with the first artifact in the link section associated with the particular artifact as discussed above.

At a block 510, a reverse link is stored from the second artifact to the first artifact. The reverse link is stored in the link second associated with the second artifact. In this manner, each link between two artifacts is represented as two separate links and ensure bidirectional links between any two linked artifacts.

At a block 512 it is determined whether a CSD is desired for the particular link. In one embodiment a user determines whether a CSD is to be created. In another embodiment a CSD may automatically be created for every link. In yet another embodiment, a CSD may automatically be created for a configured set of links. In the event that a CSD is not created, the method shown in FIG. 5 ends. However, if a CSD is to be created, at a block 514 a CSD is defined which includes pointers to both the first artifact and the second artifact. The CSD may also include additional information related to the link as described above.

Of course, the processing performed in blocks 508-514 may be repeated until all of the desired links between artifacts have been created. In addition, and as described below, the links may also be modified (altered added, removed) at a later time.

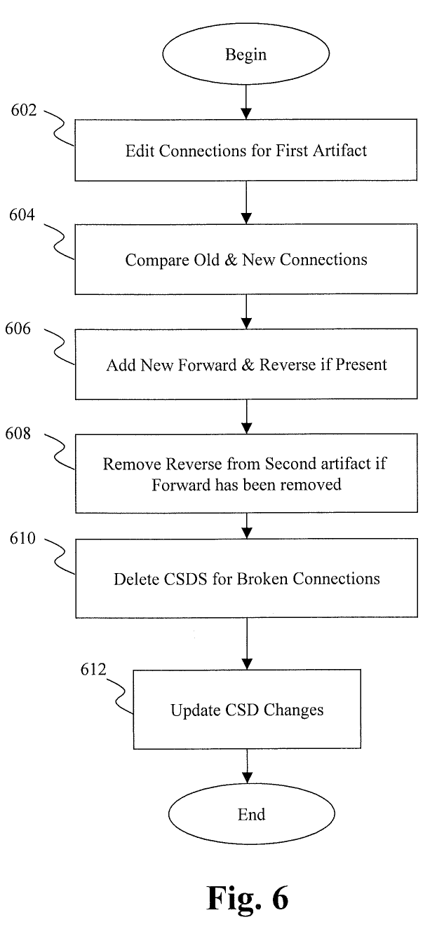

FIG. 6 is an example of a method according to one embodiment of the present inventions by which connections between a first artifact and another other artifact to which it is linked (e.g., a second artifact) may be modified. At a block 602 a connection is modified. This may be accomplished, for example moving one end of the link to a different artifact or deleting a link. In one embodiment, this may be accomplished by utilizing the user interaction module 200 (FIG. 2).

At a block 604, the old links related to the first artifact are compared with the new links. This may include keeping a log of any variations in the links whether they be a variation in the connection or any information related to the connection. Another embodiment of this could be storing the current and previous set of links for each artifacts to determine which links were deleted and to use this information to trigger the deletion of the “reverse” links. At a block 606, any new link that has been created has a forward link in the first artifact and a reverse link in the second artifact created and stored with its respective artifact. This ensures the bidirectional link nature of embodiments of the present invention. Of course, if a new CSD is created between any two artifacts, the two artifacts are pointed to by that CSD and the new CSD is saved.

At a block 608, any reverse links from the second artifact are removed if any forward link has been removed. This may be accomplished, for example, by the connection maintenance module 216. At a block 610, any CSD for a deleted connection is deleted. At a block 612, any changes to any CSD due to changes in the links are updated and saved. This can for instance be the title of the CSD if this title contains the names of the two artifacts the CSD refers to. Likewise, artifacts can be updated when they contain copies of values from the CSD. These updates are one possibility for an embodiment and might not be necessary in other implementations.

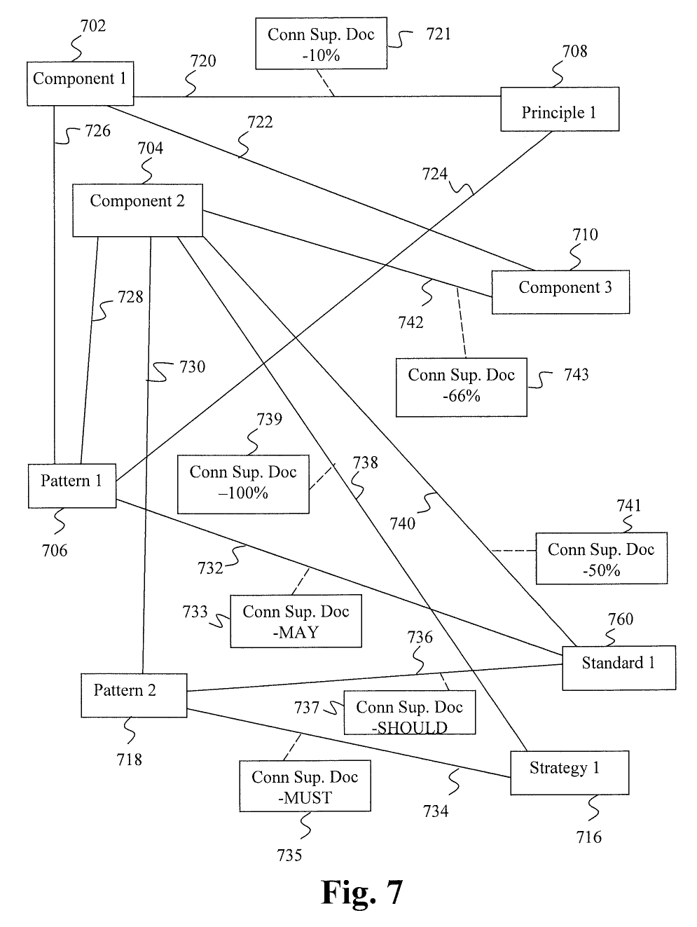

FIG. 7 shows an example of a network of interconnected artifacts according to one embodiment of the present invention. As shown, each square box represents either an artifact (ending in an even number) or a connection support document (ending in an odd number). Each link between two artifacts is shown as a solid line. The connection support document related to the link is connected to the link with a dashed line. As discussed in greater detail above, the connection support document actually points to the two artifacts, which are connected by a particular link. Each of the artifacts shown in FIG. 7 is either a component, a pattern, a strategy, a standard, or a principle. It should be understood that these artifacts are by way of example only and any of the previously discussed artifacts may be implemented.

As shown, component 1 702 is coupled to principle 1 708 by link 720, to component 3 710 by link 710 and to pattern 1 706 by link 726. The link between component 1 701 and principle 1 708 also includes a connection support document 721. In this example the connection support document 721 indicates that at least 10% of the time, component 1 702 forms a portion of principle 1 708. It should be understood that the indications shown in the CSD's of FIG. 7 are by way of example and these indications could be any type of indication based on user requirements. For example, the indications (or rules) contained in the CSD's may include, but are not limited to, pattern requirements, criticality, properties, standards and the like.

Component 2 704 is coupled via the links 728 to pattern 1 706, via the link 730 to pattern 2 718, via the link 738 to strategy 1 716, via the link 740 to standard 1 760, and via link 742 to component 3 710. The links 738 and 743 also include connection support documents indicating, respectively, that link 738 requires 100% compliance and link 742 require 66% compliance.

Pattern 1 706 is coupled to principle 1 708 by link 724 and to standard 1 760 via link 732 which includes a connection support document 733. Pattern 2 is coupled to standard 1 760 via link 736 and to strategy 1 716 via link 734. Link 736 includes a connection support document 737 indicating that the pattern should be part of the standard and link 734 is a MUST link as indicated by connection support document 735.

In one embodiment, connections can be analyzed utilizing, for example, the analysis module 220 (FIG. 2). A simple analysis may be performed, for example, by listing all interconnected artifacts. An example of such a listing may take the form, for example, of that shown in FIG. 7. In another embodiment, algorithms may be applied that analyze information about each of the artifacts to prepare a report. For example, a listing of all projects that utilize outdated products (based on the lifecycle information) may be generated. Further, embodiments of present invention may allow for algorithms to read the structured data contained in the artifacts and generate reports or other information there from. In another embodiment, connection support documents are looked up by searching for all connection support documents and selecting the one that references both artifacts connected by a particular connection.

Advantageously, storing and organizing the data related to EA as described above may allow greater modeling flexibility. For example, many models (in the EA space and beyond) were created and afterwards the static nature of the documents made them difficult to change without revising huge documents entirely. Further, in the past, each document was limited in scope and not connected to adjacent models. As such, information was stored in different and separate places and connecting them was intellectual work and necessary time and time again. The system presented here overcomes these obstacles with a new approach: information of very different types can be interconnected; small portions of it can be changed at any time as their direct neighbors do not have to be searched from documents; and new types of information can easily be added.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A computer based system for capturing and storing enterprise architecture information, the system comprising:
a database for storing artifacts, each artifact representing a portion of the enterprise architecture;
a user interaction module coupled to the database, the user interaction module including:
a structured artifact listing containing a listing of each artifact, the artifact listing including a representation of each bidirectional connection between each artifact;
a selection module for selecting one or more of the artifacts, wherein selection of an artifact causes the selected artifact and all artifacts connected to the selected artifact to be displayed; and
a connection support document and artifact viewer coupled to the structured artifact listing, the connection support document viewer configured to display connection support documents, each connection support document pointing to two connected artifacts and containing additional information about a relationship between the two linked artifacts.

2. The system of claim 1, further comprising:
logic and maintenance module coupled to the database; and
a persistence module coupled to the database.

3. The system of claim 2, wherein the persistence module further includes:
an artifact store for storing the artifacts;
a connection support document store for storing the connection support documents; and
a configuration store to store customizations to the system's behavior a metamodel store for storing definitions of each artifact type.

4. The system of claim 2, wherein the logic and maintenance module includes:
a connection maintenance module, the connection maintenance module configured to ensure that each connection between a first artifact and a second artifact is a bidirectional connection including a forward link stored in the first artifact and a reverse link stored in the second artifact.

5. The system of claim 4, wherein the connection maintenance module is further configured to delete reverse in the event that the forward link is deleted.

6. The system of claim 4, wherein the connection maintenance module is configured to delete a connection support document associated with the bidirectional connection between the first and second link is deleted.

7. The system of claim 4, wherein the first artifact includes lifecycle information stored therein and wherein the logic and maintenance module further includes:
a lifecycle management module configured to examine the lifecycle information and to notify at least one user that the first artifact is nearing or at the end of a predefined lifecycle limit.

8. The system of claim 4, wherein the logic and maintenance module further includes:
an analysis module configured to analyze the connections based on user defined criteria.

9. The system of claim 1, wherein each artifact includes a type, a name and a link section.

10. The system of claim 1, wherein the types include locations, components, patterns, principles, standards, business components, processes, interfaces, data, users, organizations, strategy, roles, evaluations, and evaluation criterion.

11. A method of storing enterprise architecture in a computer database, the method comprising:
creating a plurality of artifacts including a first artifact, a second artifact and a third artifact, each artifact having a type and an identifier;
creating a connection between the first artifact and the second artifact, the connection including a forward link stored in the first artifact pointing from the first artifact to the second artifact and a reverse link stored in the second artifact pointing from the second artifact to the first artifact; and
creating a connection support document, the connection support document including a pointer to the first artifact and a pointer to the second artifact, the connection support document further including information related to the connection between the first artifact and the second artifact.

12. The method of claim 11, further comprising:
creating a connection from the first artifact and the third artifact, the connection including a forward link stored in the first artifact pointing from the first artifact to the third artifact and a reverse link stored in the third artifact pointing from the third artifact to the first artifact.

13. The method of claim 12, further comprising:
deleting the connection between the first artifact and the second artifact, deleting including deleting the forward link pointing from the first artifact to the second artifact and deleting the reverse link pointing from the second artifact to the first artifact.

14. The method of claim 13, further comprising:
deleting the connection support document.

15. The method of claim 11, wherein each artifact includes a link section for storing connections to other artifacts.

16. The method of claim 11, wherein one or more of the artifacts is a document.

17. The method of claim 11, wherein the connection between the first artifact and the second artifact is a pattern connection that links a current to a desired state.

18. The method of claim 11, wherein the connection between the connection support document includes link requirement information.
